(19) United States
(12) Patent Application Publication
(10) Pub. No.: US 2018/0033198 A1
(43) Pub. Date: Feb. 1, 2018

(54) FORWARD DIRECTION DETERMINATION FOR AUGMENTED REALITY AND VIRTUAL REALITY

(71) Applicant: MICROSOFT TECHNOLOGY LICENSING, LLC, Redmond, WA (US)

(72) Inventors: Soren Hannibal Nielsen, Redmond, WA (US); Jonathan Ross Hoof, Redmond, WA (US)

(21) Appl. No.: 15/223,914

(22) Filed: Jul. 29, 2016

(51) Int. Cl. G06T 19/00; G06F 3/01

(52) U.S. Cl. CPC G06T 19/003; G06F 3/013; G06T 19/006

(57) ABSTRACT

In various embodiments, methods and systems for determining a forward direction for augmented reality (AR)/virtual reality (VR) are provided. A sideways vector and an up vector are measured by an AR/VR device. A cross product of the sideways vector and the up vector is calculated to obtain a forward vector. An indication from a user of the AR/VR device is received to perform an action in a forward direction and the action in the forward direction is performed in a direction of the forward vector. For example, a user can move in an AR/VR environment in the forward direction or a user interface can be provided in the AR/VR environment in the forward direction.

### BACKGROUND

Augmented reality (AR) and virtual reality (VR) provide an immersive computing experience by allowing a user to interact with computer-generated objects and, in some cases, navigate in a computer-generated world. AR overlays a view of the physical, real-world environment with computer-generated objects that provide information and allows for interactions with the computer-generated objects in the physical, real-world environment. VR provides a simulated environment where a user can interact with computer-generated objects and/or move around in the simulated environment.

Movement in an AR/VR environment can allow for further interactions by a user by allowing the user to move in different directions or to different locations in the AR/VR environment. Movement in the AR/VR environment can be performed by using an input device that allows for the movement of a user to be independent of the direction the user is facing. This allows a user to, e.g., look around in the AR/VR environment while they are moving in a particular direction or to a particular location in the AR/VR environment. As such, further improvements in AR/VR navigation are desirable to provide different types of interaction and navigation functionality in AR/VR environments.

### SUMMARY

Embodiments of the present invention are directed to providing interactions in an AR/VR environment using a forward direction determination system. At a high level, a sideways direction (e.g., via a sideways vector) of a user associated with an AR/VR device (e.g., from a first ear to a second ear) is used as a principal direction to cross with a vertical direction (e.g., via an up vector) for determining the forward direction. In operation, the forward determination system of the AR/VR device measures a sideways vector and an up vector. Using the sideways vector and the up vector, a cross product is calculated to determine a forward vector. When a user actuates an input that indicates an interaction in the forward direction, the AR/VR device provides in the AR/VR environment the interaction in the direction of the forward vector.

In some embodiments, a user can actuate an input to move in an AR/VR environment in a horizontal forward direction. The horizontal forward direction can be determined by the forward vector, allowing the user to move in the AR/VR environment in the direction of the forward vector.

In some embodiments, a user interface (UI) is provided to the user in a horizontal forward direction. A user interacting with the UI can actuate an input (e.g., look) in the horizontal forward direction to locate the UI. The UI is located in the horizontal forward direction as determined by the forward vector.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The present invention is described in detail below with reference to the attached drawing figures, wherein:

FIG. 1 is a schematic showing an exemplary forward direction determination system, in accordance with embodiments of the present invention;

FIG. 2A is an illustration of a forward vector calculated from the up vector and sideways vector when a user is looking in a horizontal direction, in accordance with embodiments of the present invention;

FIG. 2B is an illustration of a forward vector calculated from the up vector and sideways vector when a user is looking in a vertical direction, in accordance with embodiments of the present invention;

FIG. 3 is a flow diagram showing a method for implementing a forward direction determination system, in accordance with embodiments of the present invention;

FIG. 4 is an illustrated diagram showing exemplary augmented reality images of a head-mounted display device, in accordance with embodiments of the present invention;

FIG. 5 is a block diagram of an exemplary head-mounted display device, in accordance with embodiments of the present invention; and

FIG. 6 is a block diagram of an exemplary computing environment suitable for use in implementing embodiments of the present invention.

### DETAILED DESCRIPTION

Augmented reality (AR) and virtual reality (VR) provide a more immersive way for a user to interact with a computing device. For example, AR and VR systems can allow a user to interact with a computing environment in three-dimensions. In particular, a user can move/interact with the environment in a forward, backwards, upwards, downwards, and left and right sideways direction. Given that a user can move/interact in an AR/VR environment in multiple directions, determining a forward direction may be helpful to orient the user in the AR/VR environment. Knowing the forward direction may also be useful when, e.g., the user wishes to move forward in the AR/VR environments by moving an input device in the forward direction or to locate a user interface (UI) that is easier to find by the user. Generally, a user indicating a movement forward in an AR/VR environment expects to move forward relative to the position of their torso, even when the user's head or display device is facing straight up or down, or past vertical to a location behind the user. If the movement is in an unexpected direction (e.g., in a direction unexpected by the user), the user may experience motion sickness or otherwise be confused with navigation in the AR/VR environment.

An example of an application that uses a movement direction independent of a gaze direction is a game such as MINECRAFT by MOJANG AB, where the user can mine blocks directly above or below relative to their location in the AR/VR environment. For example, a user may wish to mine a block directly above the user, and then move forward to the next block to continue mining. Thus, the user may control their movement, via an input device, to move forward in the AR/VR environment while facing straight up. By determining a forward direction, the user can continue to move in the forward direction while looking in another direction to mine.

Conventional methods to determine a forward direction have used a gaze vector, usually oriented on a headset or other display device used in the AR/VR environment. By using the gaze vector and, e.g., an up vector, a sideways vector can be calculated, and the sideways vector can be used to further calculate a horizontal forward vector. The horizontal forward vector can be used to move the user in a forward direction. However, calculating the forward vector using a gaze vector has some limitations. For example, if a user is looking straight up or down, or tilts their head more than 90 degrees in an up or down direction, the forward direction may not be calculated correctly. In particular, if the user is looking straight up or down, a cross product of the gaze vector and the up vector would equal zero, potentially allowing for multiple forward directions and allowing the view in the AR/VR environment to point to an incorrect forward direction or continuously change to the multiple forward directions. For example, multiple forward directions may cause the view in the AR/VR environment to spin around as different forwards directions are calculated. Furthermore, if a user tilts their head upwards or downwards greater than 90 degrees, the forward direction may point in the opposite direction to the intended forward direction, e.g., since vector of the cross product would point in the opposite direction.

Embodiments of the present disclosure are directed to efficient methods and systems for providing interactions in an AR/VR environment using a forward direction determination system. At a high level, the forward direction determination system, by calculating a forward direction using a measured sideways vector, can avoid the issues when the user looks straight up or down or greater than 90 degrees in an up or down direction. For example, a measured sideways vector allows the cross product to be calculated from a different vector than a gaze vector, preventing the issues described above with regard to the gaze vector. In particular, a sideways vector is used instead of a gaze vector to calculate a horizontal forward vector. Since a user is less likely to tilt their head sideways 90 degrees or greater than tilting their head up or down 90 degrees or greater, calculating a horizontal forward vector from the sideways vector can be more reliable, providing the user with a more stable AR/VR environment. For example, a cross product is calculated from the sideways vector and an up vector to determine a forward vector. When a user indicates that they want to move in a forward direction (as opposed to a gaze direction) in the AR/VR environment, the user's movement in the AR/VR environment is in the direction of the horizontal forward vector.

As used herein, the term “forward direction” or “horizontal forward direction” is defined as a direction on a two-dimensional plane along the X and Y axes, i.e., horizontal plane. Generally, the forward direction is the direction along the X and Y axes that the body of the user is facing. However, the forward direction is not limited to the direction of the body of the user and can be a horizontal direction of the head of the user when faced parallel to the horizontal plane.

As used herein, the term “up vector” is defined as a vector traveling in an opposite direction of gravity. Thus, an up vector can have an origination at the point of original gravity toward a direction skyward directly away from the point of original gravity.

As used herein, the term “sideways vector” is defined as a vector originating from a point at one side of the AR/VR device to the other side of the AR/VR device relative to a horizontal forward direction on the AR/VR device. For example, if the AR/VR device is a headset worn by the user, the sideways vector can be a vector measured from one ear of the user to the other ear.

As used herein, the term “gaze direction” is a direction of the AR/VR device is pointing towards when looked from the perspective of the user. For example, if the AR/VR device is a headset worn by the user, the gaze direction is the direction the user's head (e.g., eyes) is looking towards. If the AR/VR device is a mobile device, such as a mobile phone, the gaze direction can be the direction of a camera opposite the display of the mobile device.

As used herein, the terms “direction” and “vector” are used interchangeably. Generally, a vector is a mathematical representation of a direction. A vector can have an X, Y, and Z value representing the magnitude of the vector in the X, Y, and Z directions.

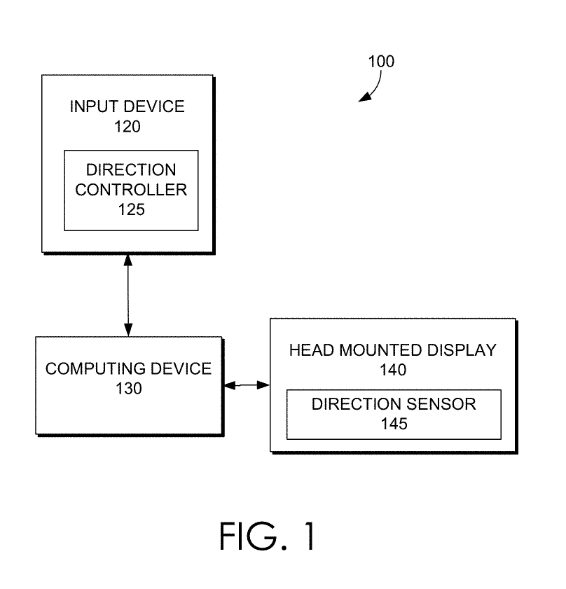

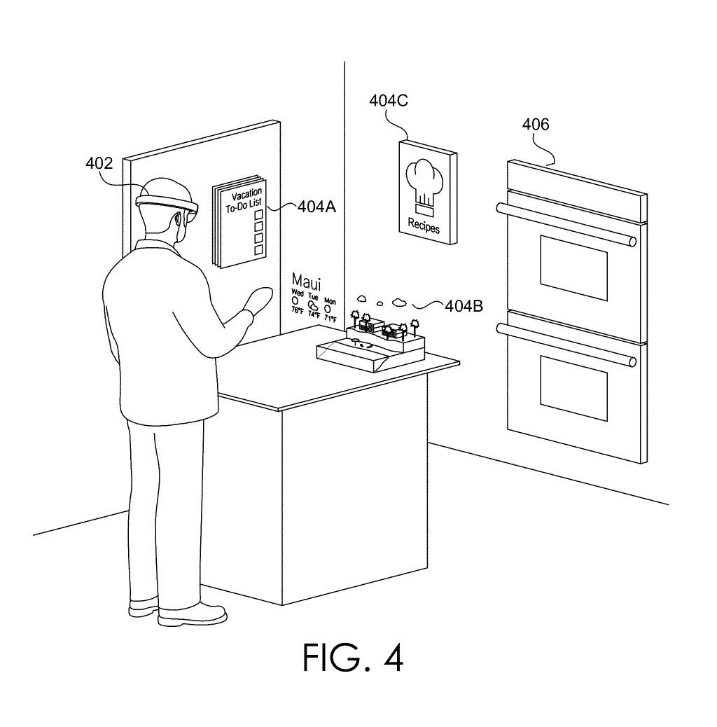

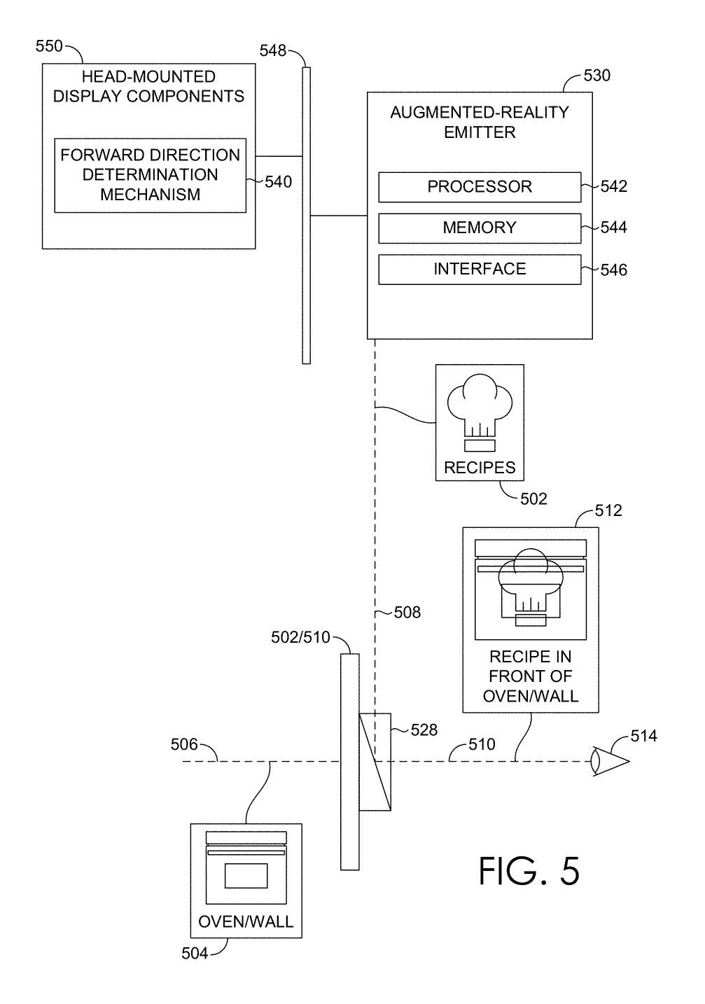

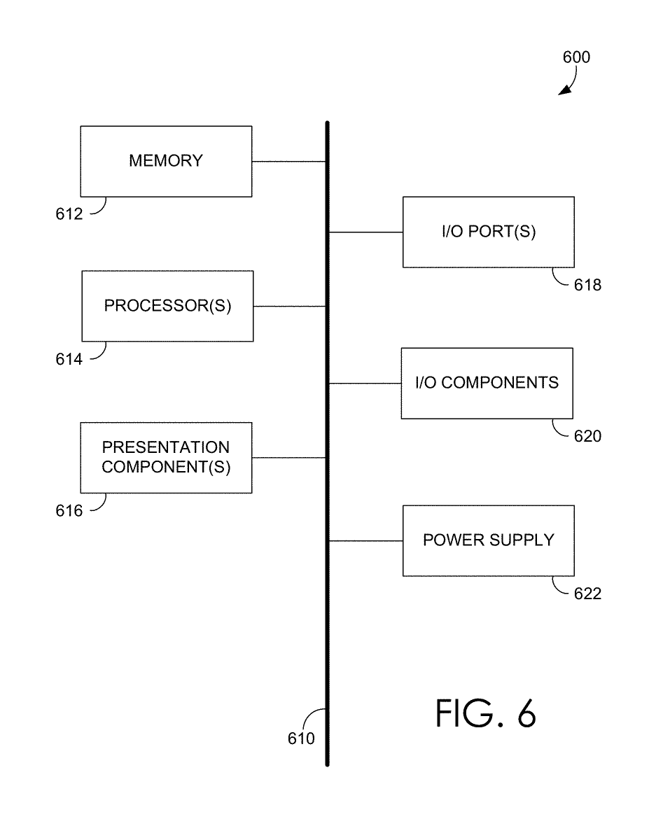

With reference to FIG. 1, embodiments of the present disclosure can be discussed with reference to a forward direction determination system 100 for implementing functionality described herein. The forward direction determination system 100 may be part of an AR/VR device or may be coupled to an AR/VR device to determine a forward direction in an AR/VR environment displayed to the user. The forward direction determination system 100 includes an input device 120, a computing device 130, and a head mounted display (HMD) 140 device. The computing device 140 may include any type of computing device described below with reference to FIG. 6, and the HMD 140 may include any type of HMD or augmented reality device described below with reference to FIGS. 4 and 5.

For detailed discussion purposes, the augmented reality device is an exemplary head mounted display (HMD) 150 device, but other types of augmented reality devices are contemplated with embodiments of the present disclosure. The HMD 140 is a scene-aware device that understands elements surrounding a real world environment and generates virtual objects to display as augmented reality images or virtual reality images to a user. HMD 140 can be configured to capture the real world environment based on components of the HMD 140. The HMD 140 can include a depth camera and sensors that support understanding elements of a scene or environment, for example, generating a 3-D mesh representation of a real world environment. In particular, the HMD 140 also includes a direction sensor 145 to determine direction vectors for determining a forward direction. In this regard, the computing device 130 and/or HMD 140 can include functionality (e.g., augmented reality or virtual reality experiences) that can be supported using the input device 120 operating based on the direction controller 125. The forward direction determination system 100 can implement a mechanism for performing the functionality described in the present disclosure. A mechanism as used herein refers to any device, process, or service or combination thereof. A mechanism may be implemented using components as hardware, software, firmware, a special-purpose device, or any combination thereof. A mechanism may be integrated into a single device or it may be distributed over multiple devices. The various components of a mechanism may be co-located or distributed. The mechanism may be formed from other mechanisms and components thereof.

Turning to the components of FIG. 1, the input device 120 includes a direction controller 125. At a high level, the direction controller 125 allows the user to move in an AR/VR environment. The direction controller 125 sends commands to the computing device 130 to move the user in the AR/VR environment in a direction indicated by the direction controller 125. The input device 120 can also include components that allow the user to interact with objects in the AR/VR environment. For example, the input device can allow a user to interact with a user interface (UI) displayed in the AR/VR environment.

The HMD 140 includes a direction sensor 145. The direction sensor 145 measures the orientation of the HMD 140. For example, the direction sensor 145 may measure an up direction (i.e., direction of gravity) and a sideways direction (e.g., the direction from one ear of the user to the other). In some embodiments, the direction sensor 145 is one or more accelerometers that detect the position of the HMD 140.

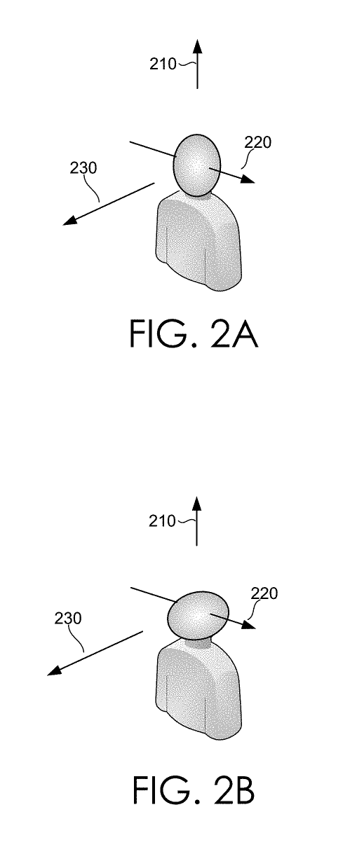

Turning to FIG. 2A, FIG. 2A shows a forward vector 230 as calculated from the up vector 210 and sideways vector 220 when a user is looking in a horizontal direction. The up vector 210 points in a direction opposite gravity, e.g., straight up. The sideways vector 220 points to a direction from one ear of the user to the other. As shown in FIG. 2A, the sideways vector 220 goes from a right ear to a left ear of the user. Although a sideways vector going in the direction of a right ear to a left ear is depicted, it should be understood that the direction of the sideways vector can point in the opposite direction (e.g., from a left ear to a right ear of the user). Based on the cross product calculation, the direction of the cross product vector can be reversed to point in a forward direction. The forward vector 230 is calculated by the cross product of the sideways vector 220 and the up vector 210. Generally, the cross product of two vectors is a vector pointing in a direction perpendicular to the two vectors. Since one of the vectors is an up vector the cross product of the two vectors will point in a direction along the horizontal plane. Thus, the forward vector 230 calculated from the cross product of the two vectors point in a direction along the horizontal plane perpendicular to the sideways vector, e.g., the horizontal forward direction.

Turning now to FIG. 2B, FIG. 2B shows a forward vector 230 as calculated from a sideways vector 220 and an up vector 210 when a user is looking in a vertical direction. As previously described in FIG. 2A, the up vector 210 points in a direction opposite gravity, e.g., straight up. The sideways vector 220 points to a direction from one ear to the other, e.g., from a right ear to a left ear of the user. The forward vector 230 is calculated by the cross product of the sideways vector 220 and the up vector 210.

As shown in FIGS. 2A and 2B, the up vector 210 and the sideways vector 220 point in the same direction in FIGS. 2A and 2B. If the user only moves their head in an up or down direction and does not tilt their head sideways, the values of the up vector 210 and the sideways vector 220 with remain the same. Thus, the calculation of the forward vector 230 in FIGS. 2A and 2B is the same. This allows the forward vector 230 to maintain the same value, even if the user is looking straight up or down.

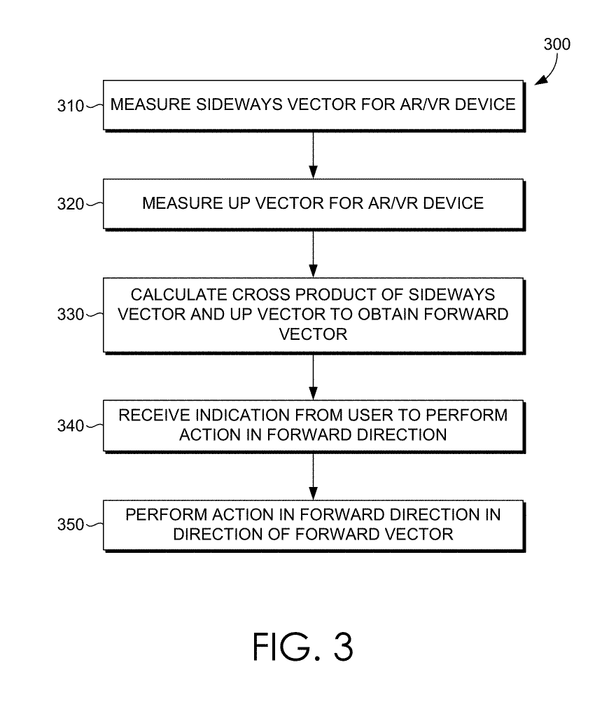

With reference to FIG. 3, a method for implementing a forward direction determination system is provided. Initially at block 310, a sideways vector is measured for an AR/VR device. In some embodiments, the AR/VR device collects data from one or more sensors. For example, the one or more sensors can include an accelerometer. The accelerometer can determine direction of the AR/VR device by using the data from the accelerometer and gravity to determine whether the device is oriented in a certain position. For example, if the AR/VR device is a headset, the one or more sensors can detect which direction the headset is facing (with respect to a gaze direction of the user). The sensor data can be collected from the AR/VR device. A sideways direction can be determined based on an orientation of the AR/VR device. For example, if a user is wearing a headset, the orientation of the device can be determined (e.g., the headset will have a left and right direction when worn properly by the user). The sideways vector can be measured in the sideways direction of the AR/VR device using the sensor data.

At block 320, an up vector is measured for the AR/VR device. For example, the one or more sensors can include a gravity sensor, e.g., accelerometer. The gravity sensor indicates the direction of gravity with respect to the AR/VR device. An up vector can be determined using the data from the gravity sensor.

At block 330, a horizontal forward vector is calculated. For example, the horizontal forward vector can be calculated from the sideways and up vectors using a cross product of the two vectors. The cross product of two vectors is a third vector that is perpendicular to the first two vectors. Since one of the vectors is an up vector, the third vector with point somewhere along the horizontal plane perpendicular to the sideways vector.

If the sideways vector points parallel to the up vector or beyond parallel, the cross product may be indefinite or point in an opposite direction to the forward vector. Thus, in some embodiments, a second horizontal forward vector is also calculated from the gaze vector. For example, a gaze vector can also be measured. A cross product of the gaze vector and the up vector is calculated to obtain a calculated sideways vector, which is then crossed with the up vector to obtain a second calculated horizontal forward vector. The second calculated horizontal forward vector can be used to cross check the horizontal forward vector calculated from the sideways vector. This allows a forward vector to be calculated even when the measured sideways vector is near vertical (i.e., the head of the user is tiled sideways 90 degrees to the left or right). Since the measured sideways vector and the measured gaze vector are always perpendicular to each other (they are fixed with relation to the AR/VR device), the calculated forward vector and second calculated forward vector should point in the same forward direction except in the cases when either the measured gaze vector or sideways vector is parallel to the up vector. In some embodiments, the second calculated forward vector is used for the horizontal forward direction when the measured sideways vector is pointing in the same direction as the up vector.

At block 340, an indication from the user to perform an action in the forward direction is received. For example, if a user wishes to move forward in the AR/VR environment relative to their current position or location, the user can provide an indication to move forward. The indication to move forward can be provided by an input device, where the controls of the input device allow the user to indicate a forward movement. In some embodiments, the user may want to interact with an object in the forward direction. For example, a UI may be provided to the user in a forward direction, and the user can interact with the UI. This allows the UI to be located in a location convenient to the user (e.g., a location that allows the user to not have to search for the UI), without other interfering with their experience in the AR/VR environment. For example, if a UI is located somewhere with respect to the user's gaze location, it may need to be located constantly within view of the user's gaze, otherwise detracting from the user experience.

At block 350, the action to be performed in the forward direction is performed in the direction of the forward vector. For example, if the user indicates that they want to move in a forward direction (e.g., by pointing an input device in a forward direction), the AR/VR environment is moved in the direction of the forward vector. Thus, a user can be looking around in the AR/VR environment, but be moving in a forward direction in the AR/VR environment.

In some embodiments, a user interface (UI) is provided in the horizontal forward direction. When looking in different direction, e.g., looking straight up, it may be beneficial for the UI to be in the forward direction when the user returns their head to a normal orientation. Otherwise it may be difficult to find the UI, e.g., the user would have to look around for the location of the UI.

Calculating the forward direction based on a sideways vector has some advantages over conventional methods. For example, in one conventional method, the method operates to calculate a sideways vector from the gaze vector. By using the sideways vector, calculations are reduced since the sideways vector does not have to be calculated (the sideways is measured from sensors of the AR/VR device). Furthermore, it has the advantage of working in more scenarios than other conventional methods. For example, a user is more likely to look straight up or down (tilt their head 90 degrees in an up or down direction) than they are to tilt their head 90 or more degrees sideways. Thus, the user does not experience the problem of an indefinite forward direction or the forward direction pointing backwards when looking straight up or down as in the conventional method. Furthermore, calculating both the forward direction based on a sideways vector and based on a gaze vector also has some advantages over conventional methods. For example, a forward direction can be determined even when a user's head is tilted in 90 degrees in any direction, thereby improving the reliability of the AR/VR device.

With reference to FIG. 4, exemplary images of a head-mounted display (HMD) device 402 are depicted. Augmented reality images (e.g., 404A, 404B and 404C), comprising corresponding virtual images provided by the HMD 402 device, generally include the virtual images that appear superimposed on a background and may appear to interact with or be integral with the background 406. The background 406 is comprised of real-world scene, e.g., a scene that a user would perceive without augmented reality image emitted by the HMD 402 device. For example, an augmented reality image can include the recipe book icon 404C that appears superimposed and hanging in mid-air in front of the cooking oven or wall of the background 406.

Turning to FIG. 5, the HMD device 502 having a forward direction determination mechanism 540 is described in accordance with an embodiment described herein. The HMD device 502 includes a see-through lens 510 which is placed in front of a user's eye 514, similar to an eyeglass lens. It is contemplated that a pair of see-through lenses 510 can be provided, one for each eye 514. The lens 510 includes an optical display component 528, such as a beam splitter (e.g., a half-silvered mirror). The HMD device 502 includes an augmented reality emitter 530 that facilitates projecting or rendering the of augmented reality images. Amongst other components not shown, the HMD device also includes a processor 542, memory 544, interface 546, a bus 548, and additional HMD components 550. The augmented reality emitter 530 emits light representing a virtual image 502 exemplified by a light ray 508. Light from the real-world scene 504, such as a light ray 506, reaches the lens 510. Additional optics can be used to refocus the virtual image 502 so that it appears to originate from several feet away from the eye 514 rather than one inch away, where the display component 528 actually is. The memory 544 can contain instructions which are executed by the processor 542 to enable the augmented reality emitter 530 to perform functions as described. One or more of the processors can be considered to be control circuits. The augmented reality emitter communicates with the additional HMD components 550 using the bus 548 and other suitable communication paths.

Light ray representing the virtual image 502 is reflected by the display component 528 toward a user's eye, as exemplified by a light ray 510, so that the user sees an image 512. In the augmented-reality image 512, a portion of the real-world scene 504, such as, a cooking oven is visible along with the entire virtual image 502 such as a recipe book icon. The user can therefore see a mixed-reality or augmented-reality image 512 in which the recipe book icon is hanging in front of the cooking oven in this example.

Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Having described embodiments of the present invention, an exemplary operating environment in which embodiments of the present invention may be implemented is described below in order to provide a general context for various aspects of the present invention. Referring initially to FIG. 6 in particular, an exemplary operating environment for implementing embodiments of the present invention is shown and designated generally as computing device 600. Computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 6, computing device 600 includes a bus 610 that directly or indirectly couples the following devices: memory 612, one or more processors 614, one or more presentation components 616, input/output ports 618, input/output components 620, and an illustrative power supply 622. Bus 610 represents what may be one or more busses (such as an address bus, data bus, or combination thereof). Although the various blocks of FIG. 6 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. We recognize that such is the nature of the art, and reiterate that the diagram of FIG. 6 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 6 and reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 600. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors that read data from various entities such as memory 612 or I/O components 620. Presentation component(s) 616 present data indications to a user or other device. Exemplary presentation components include a display device, speaker, printing component, vibrating component, etc.

I/O ports 618 allow computing device 600 to be logically coupled to other devices including I/O components 620, some of which may be built in. Illustrative components include a microphone, joystick, game pad, satellite dish, scanner, printer, wireless device, etc.

Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present invention are described with reference to a head-mounted display device as an augmented reality device; however the head-mounted display device depicted herein is merely exemplary. Components can be configured for performing novel aspects of embodiments, where configured for comprises programmed to perform particular tasks or implement particular abstract data types using code. Further, while embodiments of the present invention may generally refer to the head-mounted display device and the schematics described herein, it is understood that the techniques described may be extended to other implementation contexts.

Embodiments of the present invention have been described in relation to particular embodiments which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

The invention claimed is:

1. A method of determining a forward direction for an augmented reality (AR)/virtual reality (VR) device, comprising:
measuring a sideways vector for the AR/VR device;
measuring an up vector for the AR/VR device;
calculating a cross product of the sideways vector and the up vector to obtain a forward vector;
receiving an indication from a user of the AR/VR device to perform an action in a forward direction; and
performing the action in the forward direction in a direction of the forward vector.

2. The method of claim 1, wherein measuring the sideways vector comprises:
collecting sensor data from the AR/VR device;
determining a sideways direction based on an orientation of the AR/VR device; and
measure the sideways vector in the sideways direction using the sensor data for the AR/VR device.

3. The method of claim 1, wherein the sideways vector is measured by one or more accelerometers in the AR/VR device.

4. The method of claim 1, wherein the up vector is measured by one or more accelerometers in the AR/VR device.

5. The method of claim Error! Reference source not found., wherein the action in the forward direction is moving the user in an AR/VR environment in the forward direction with respect to a current location of the user.

6. The method of claim 1, wherein the action in the forward direction is interacting with an object in an AR/VR environment located in the forward direction.

7. The method of claim 1, wherein the method further comprises displaying a user interface in the forward direction; and wherein the action in the forward direction is interacting with the user interface.

8. The method of claim 1, wherein the AR/VR device is facing in a straight up or down direction.

9. The method of claim 1, wherein the AR/VR device is facing in a direction greater than 90 degrees from a direction on a horizontal plane with respect to a position of the user.

10. An augmented reality (AR)/virtual reality (VR) device comprising:
a processor;
one or more sensors that measure an orientation of the AR/VR device; and
memory, the memory comprising instructions to:
measure a sideways vector using the one or more sensors;
measure an up vector using the one or more sensors;
calculate a cross product of the sideways vector and the up vector to obtain a forward vector;
receive an indication from a user of the AR/VR device to perform an action in a forward direction; and
perform the action in the forward direction in a direction of the forward vector.

11. The computing device of claim 10, wherein the one or more sensors is a gravity sensor.

12. The computing device of claim 10, wherein measuring the sideways vector comprises:
collecting sensor data from the one or more sensors; and
calculating the sideways vector from the one or more sensors.

13. The computing device of claim 10, wherein the action in the forward direction is moving the user in an AR/VR environment in the forward direction with respect to a current location of the user.

14. The computing device of claim 10, wherein the action in the forward direction is interacting with an object in an AR/VR environment located in the forward direction.

15. The computing device of claim 10, wherein the memory further comprises instructions to display a user interface in the forward direction; and wherein the action in the forward direction is interacting with the user interface.

16. The computing device of claim 10, wherein the AR/VR device is facing in a straight up or down direction.

17. A system comprising:
a processor and memory, the memory comprising instructions to:
receive a sideways vector using one or more sensors for an AR/VR device;
receive an up vector using the one or more sensors for the AR/VR device;
calculate a cross product of the sideways vector and the up vector to obtain a forward vector;
receive an indication from a user of the AR/VR device to perform an action in a forward direction; and
send instructions to the AR/VR device to perform the action in the forward direction in a direction of the forward vector.

18. The system of claim 17, wherein the action in the forward direction is moving the user in an AR/VR environment in the forward direction with respect to a current location of the user.

19. The system of claim 17, wherein the memory further comprises instructions to:
receive a gaze vector using the one or more sensors;
calculate a cross product of the gaze vector and the up vector to obtain a second sideways vector; and
calculate a cross product of the second sideways vector and the up vector to obtain a second forward vector.

20. The system of claim 17, wherein the AR/VR device is facing in a straight up or down direction.
